(19) United States
(12) Patent Application Publication
(10) Pub. No.: US 2013/0034121 A1
(43) Pub. Date: Feb. 7, 2013

(54) SEMICONDUCTOR MEMORY DEVICE INCLUDING TEMPERATURE TEST CIRCUIT

(71) Applicant: Seong Seop LEE, Icheon-si (KR)

(72) Inventor: Seong Seop LEE, Icheon-si (KR)

(73) Assignee: HYNIX SEMICONDUCTOR INC., Icheon-si (KR)

(21) Appl. No.: 13/337,037

(22) Filed: Dec. 23, 2011

(30) Foreign Application Priority Data
Aug. 5, 2011 (KR) 10-2011-0078292

(51) Int. Cl. G01K 13/00

(52) U.S. Cl. 374/152; 374/E13.001

(57) ABSTRACT

A semiconductor memory device includes: a temperature sensor configured to select first and second selection reference voltages selected in a test mode as an input reference voltage according to first and second counting signals which are sequentially counted, compare the selected input reference voltage with a level of a variable voltage which changes according to internal temperature, and generate a temperature flag signal containing information on the internal temperature; and a temperature test circuit configured to output the first and second counting signals at a time point where a level of the temperature flag signal changes.

### CROSS-REFERENCES TO RELATED APPLICATIONS

The present application claims priority under 35 U.S.C 119(a) to Korean Application No. 10-2011-0078292, filed on Aug. 5, 2011, in the Korean intellectual property Office, which is incorporated herein by reference in its entirety set forth in full.

### BACKGROUND

With broadening uses of high-performance electronic systems such as a personal computer and electronic communication equipment, the efforts to highly integrate a semiconductor memory device such as dynamic random access memory (DRAM) continue. In the case of a semiconductor memory device mounted in a mobile device such as a mobile phone or notebook computer, which is operated by a battery, various attempts, such as an operating current control and a standby current control, have been made to reduce power consumption.

A data retention characteristic of the DRAM memory cell is very sensitive to temperature. Therefore, operation conditions of circuit blocks in a semiconductor memory device need to be controlled depending on a change in internal temperature. For example, the DRAM used in the mobile device controls a refresh period depending on a change in internal temperature of the semiconductor memory device. Also, temperature sensors such as a digital temperature sensor regulator (DTSR), an analog temp sensor regulator (ATSR), and digital temperature compensated self refresh (DTCSR) are used for monitoring the change of the temperature.

According to a known art, a temperature sensor compares a variable voltage, having a level which changes depending on the temperature, with a reference voltage having a constant level, and generates a flag signal containing information on the temperature. Here, the level of the reference voltage is adjusted in order to correct a change in manufacturing process of the semiconductor memory device by detecting a flag signal for each reference voltage in a wafer test step.

However, as the number of reference voltages used in the temperature sensor increases, the number of flag signals which are to be detected in the wafer test step increases. Therefore, the test time increases.

### SUMMARY

An embodiment of the present invention relates to a semiconductor memory device including a temperature test circuit capable of reducing a test time.

In an embodiment, a semiconductor memory device includes: a temperature sensor configured to select first and second selection reference voltages selected in a test mode as an input reference voltage according to first and second counting signals which are sequentially counted, compare the selected input reference voltage with a level of a variable voltage which changes according to internal temperature, and generate a temperature flag signal containing information on the internal temperature; and a temperature test circuit configured to output the first and second counting signals at a time point where a level of the temperature flag signal changes.

In an embodiment, a semiconductor memory device includes: a temperature sensor configured to select first and second selection reference voltages selected in a test mode as an input reference voltage according to first and second counting signals which are sequentially counted, compare the selected input reference voltage with a level of a variable voltage which changes according to internal temperature, and generate a temperature flag signal containing information on the internal temperature; a first code converter configured to convert codes of the first and second counting signals; a temperature test circuit configured to output the first and second counting signals of which the codes were converted by the first code converter, at a time point where a level of the temperature flag signal changes; and a second code converter configured to recover the codes of the first and second counting signals outputted by the temperature test circuit.

### BRIEF DESCRIPTION OF THE DRAWINGS

The above and other aspects, features and other advantages will be more clearly understood from the following detailed description taken in conjunction with the accompanying drawings, in which:

FIG. 1 is a block diagram of a semiconductor memory device in accordance with an embodiment of the present invention;

FIG. 2 is a block diagram of a temperature sensor included in the semiconductor memory device of FIG. 1;

FIG. 3 is a block diagram of a voltage pulse generation unit included in the temperature sensor of FIG. 2;

FIG. 4 is a configuration diagram of a temperature test circuit included in the semiconductor memory device of FIG. 1; and

FIG. 5 is a block diagram of a semiconductor memory device in accordance with an embodiment of the present invention.

### DESCRIPTION OF SPECIFIC EMBODIMENTS

Hereinafter, embodiments of the present invention will be described with reference to accompanying drawings. However, the embodiments are for illustrative purposes only and are not intended to limit the scope of the invention.

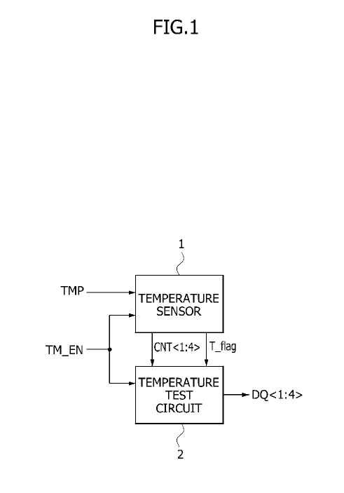

FIG. 1 is a block diagram of a semiconductor memory device in accordance with an embodiment of the present invention.

Referring to FIG. 1, the semiconductor memory device in accordance with an embodiment of the present invention includes a temperature sensor 1 and a temperature test circuit 2. The temperature sensor 1 is configured to receive a test mode pulse TMP in a test mode which is performed when a test mode enable signal TM_EN is enabled, generate first to fourth counting signals CNT<1:4> which are sequentially counted, and generate a temperature flag signal T_flag containing information on internal temperature. The temperature test circuit 2 is configured to output the first to fourth counting signals CNT<1:4> to first to fourth data pads DQ<1:4> at a time point where the level of the temperature flag signal T_flag changes.

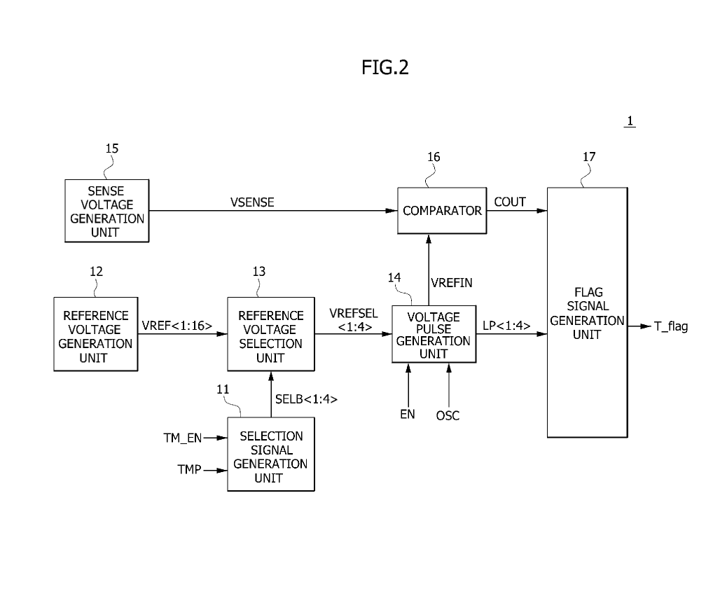

Referring to FIG. 2, the temperature sensor 1 includes a selection signal generation unit 11, a reference voltage generation unit 12, a reference voltage selection unit 13, a voltage pulse generation unit 14, a sense voltage generation unit 15, a comparator 16, and a flag signal generation unit 17.

The selection signal generation unit 11 is configured to generate first to fourth selection signals SELB<1:4> which are selectively enabled according to the test mode pulse TMP in the test mode which is performed when the enabled test mode enable signal TM_EN is inputted. According to an example, the selection signal generation unit 11 enables the first selection signal SELB<1> among the first to fourth selection signals SELB<1:4> when a first pulse of the test mode pulse TMP is inputted in the test mode, and enables the second selection signal SELB<2> among the first to fourth selection signals SELB<1:4> when a second pulse of the test mode pulse TMP is inputted. Also, the selection signal generation unit 11, according to an example, enables the third selection signal SELB<3> among the first to fourth selection signals SELB<1:4> when a third pulse of the test mode pulse TMP is inputted, and enables the fourth selection signal SELB<4> among the first to fourth selection signals SELB<1:4> when a fourth pulse of the test mode pulse TMP is inputted. Further, a signal which is enabled among the first to fourth selection signals SELB<1:4> according to a pulse of the test mode pulse TMP may be set in various manners.

The reference voltage generation unit 12 may include a plurality of resistors, and is configured to divide a power supply voltage or internal voltage. Also, the reference voltage generation unit 12 may generate first to 16th reference voltages VREF<1:16> each having a level corresponding to the internal temperature of the semiconductor memory device.

The reference voltage selection unit 13 is configured to select first to fourth selection reference voltages VREFSEL<1:4> among the first to 16th reference voltages VREF<1:16> in response to the first to fourth selection signals SELB<1:4>, and output the selected reference voltages. According to an example, when the first selection signal SELB<1> is enabled, the reference voltage selection unit 13 outputs the first reference voltage VREF<1>, the fifth reference voltage VREF<5>, the ninth reference voltage VREF<9>, and the 13th reference voltage VREF<13> as the first to fourth selection reference voltages VERFSEL<1:4>. Furthermore, according to an example, when the second selection signal SELB<2> is enabled, the reference voltage selection unit 13 outputs the second reference voltage VREF<2>, the sixth reference voltage VREF<6>, the tenth reference voltage VREF<10>, and the 14th reference voltage VREF<14> as the first to fourth selection reference voltages VERFSEL<1:4. Furthermore, according to an example, when the third selection signal SELB<3> is enabled, the reference voltage selection unit 13 outputs the third reference voltage VREF<3>, the seventh reference voltage VREF<7>, the 11th reference voltage VREF<11>, and the 15th reference voltage VREF<15> as the first to fourth selection reference voltages VERFSEL<1:4>. Furthermore, according to an example, when the fourth selection signal SELB<4> is enabled, the reference voltage selection unit 13 outputs the fourth reference voltage VREF<4>, the eighth reference voltage VREF<8>, the 12th reference voltage VREF<12>, and the 16th reference voltage VREF<16> as the first to fourth selection reference voltages VERFSEL<1:4>. The reference voltages which are selected from the first to 16th reference voltages VREF<1:16> by the reference voltage selection unit 13 and outputted as the first to fourth selection reference voltage VREFSEL<1:4> may be set in various manners depending on embodiments.

The voltage pulse generation unit 14 is configured to be driven in response to an enable signal EN which is enabled when entering the test mode, sequentially output the first to fourth selection reference voltages VREFSEL<1:4> as an input reference voltage VREFIN in response to an oscillation signal OSC, and sequentially generate first to fourth latch pulses LP<1:4> in response to the oscillation signal OSC.

The sense voltage generation unit 15 is configured to sense the internal temperature of the semiconductor memory device and generate a sense voltage VSENSE. The sense voltage generation unit 15 is implemented by using a resistor or MOS transistor of which current drivability may vary depending on the internal temperature of the semiconductor memory device.

The comparator 16 is configured to compare the levels of the sense voltage VSENSE and the input reference voltage VREFIN, and generate a comparison output signal COUT which is enabled to a logic high level, according to an example, when the sense voltage VSENSE is lower than the input reference voltage VREFIN.

The flag signal generation unit 17 is configured to output the comparison output signal COUT as a temperature flag signal T_flag in synchronization with the first to fourth latch pulses LP<1:4>.

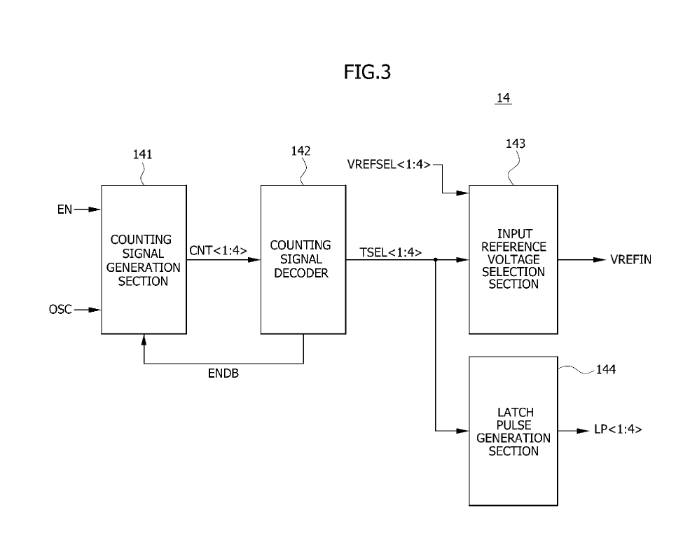

Referring to FIG. 3, the voltage pulse generation unit 14 includes a counting signal generation section 141, a counting signal decoder 142, an input reference voltage selection section 143, and a latch pulse generation section 144.

The counting signal generation section 141 is configured to be driven in response to the enable signal EN and generate the first to fourth counting signals CNT<1:4> which are counted in response to the oscillation signal OSC.

The counting signal decoder 142 is configured to receive the first to fourth counting signals CNT<1:4>, decode the received signals, and generate first to fourth test selection signals TSET<1:4> and an end signal ENDB. The first to fourth test selection signals TSEL<1:4> are sequentially enabled by the counted first to fourth counting signals CNT<1:4>, and the end signal ENDB is enabled after all of the first to fourth test selection signals TSEL<1:4> are enabled.

The input reference voltage selection unit 143 is configured to select one of the first to fourth selection reference voltage VREFSEL<1:4> as an input reference voltage VREFIN in response to the first to fourth test selection signals TSEL<1:4> and output the input reference voltage VREFIN. For example, the input reference voltage selection unit 143 may be implemented in such a manner that, when the first test selection signal TSEL<1> is enabled, the first selection reference voltage VREFSEL<1> is selected as the input reference voltage VREFIN, when the second test selection signal TSEL<2> is enabled, the second selection reference voltage VREFSEL<2> is selected as the input reference voltage VREFIN, when the third test selection signal TSEL<3> is enabled, the third selection reference voltage VREFSEL<3> is selected as the input reference voltage VREFIN, and when the fourth test selection signal TSEL<4> is enabled, the fourth selection reference voltage VREFSEL<4> is selected as the input reference voltage VREFIN.

The latch pulse generation section 144 is configured to generate the first to fourth latch pulses LP<1:4> in synchronization with the first to fourth test selection signals TSEL<1:4>. According to an example, the latch pulse generation section 144 may be implemented in such a manner that, when the first test selection signal TSEL<1> is enabled, the first latch pulse LP<1> is generated, when the second test selection signal TSEL<2> is enabled, the second latch pulse LP<2> is generated, when the third test selection signal TSEL<3> is enabled, the third latch pulse LP<3> is generated, and when the fourth test selection signal TSEL<4> is enabled, the fourth latch pulse LP<4> is generated.

The temperature sensor 1, configured in such a manner, internally selects the first to fourth selection reference voltages VREFSEL<1:4> among the first to 16th reference voltages VREF<1:16> in response to the first to fourth selection signals SELB<1:4> which are selectively enabled according to the pulse number of the test mode pulse TMP, when the enabled test mode enable signal TM_EN is inputted to perform the test mode. Furthermore, the temperature sensor 1 internally and sequentially outputs the first to fourth selection reference voltages VREFSEL<1:4> as the input reference voltage VREFIN in response to the oscillation signal OSC, and generates the comparison output signal COUT by comparing the input reference voltage VREFIN with the sense voltage VSENSE. Furthermore, the temperature sensor 1 outputs the comparison output signal COUT as the temperature flag signal T_flag in synchronization with the first to fourth latch pulses LP<1:4> which are sequentially generated in response to the oscillation signal OSC.

In short, the temperature sensor 1 controls the level of the input reference voltage VREFIN according to the pulse number of the test mode pulse TMP in the test mode, compares the input reference voltage VREFIN and the sense voltage VSENSE, and generates the temperature flag signal T_flag.

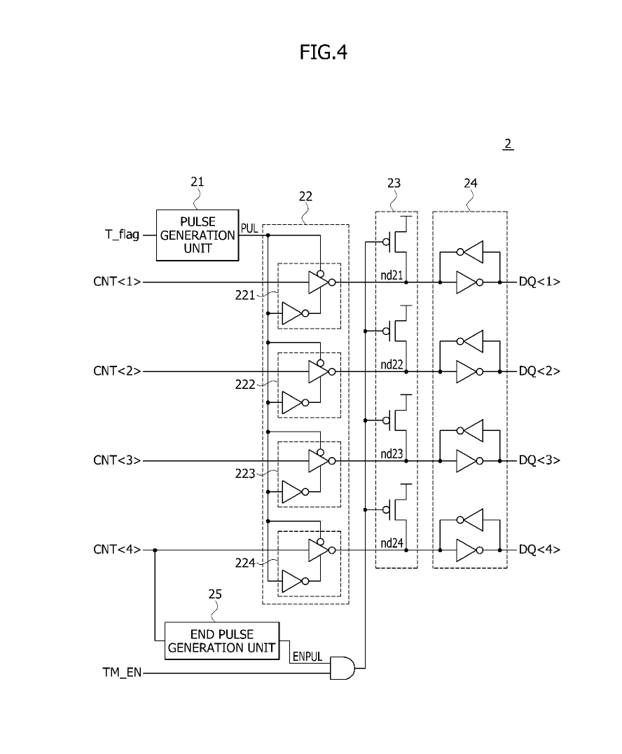

Referring to FIG. 4, the temperature test circuit 2 includes a pulse generation unit 21, a buffer unit 22, a reset unit 23, a latch unit 24, and an end pulse generation unit 25. The pulse generation unit 21 is configured to generate a pulse signal PUL at a time point where the level of the temperature flag signal T_flag changes. The buffer unit 22 includes first to fourth buffers 221 to 224 which are configured to buffer and output the first to fourth counting signals CNT<1:4> when the pulse of the pulse signal PUL is generated. The reset unit 23 is configured to pull-up drive and reset output nodes nd21 to nd24 of the buffer unit 22 after all of the first to fourth counting signals CNT<1:4> are sequentially enabled. The latch unit 24 is configured to latch signals of the output nodes nd21 to nd24 and output the latched signals to first to fourth data pads DQ<1:4>. The end pulse generation unit 25 is configured to generate a pulse of an end pulse ENPUL at a time point where the fourth counting signal CNT<4> is enabled.

The temperature test circuit 2, configured in such a manner, buffers the first to fourth counting signals CNT<1:4> at a time point where the level of the temperature flag signal T_flag changes, and outputs the buffered signals to the first to fourth data pads DQ<1:4>.

The semiconductor memory device in accordance with an embodiment of the present invention may check the levels of the first to fourth counting signals CNT<1:4> at a time point where the level of the temperature flag signal T_flag changes, through the first to fourth data pads DQ<1:4>, when the temperature sensor 1 controls the level of the input reference voltage VREFIN to perform the test mode for generating the temperature flag signal T_flag. Therefore, the semiconductor memory device may check an enabled signal among the first to fourth counting signals CNT<1:4> and select a reference voltage to be outputted as the input reference voltage VREFIN among the first to 16th reference voltages VREF<1:16>, thereby compensating for a change in the manufacturing process of the semiconductor memory device. As such, the semiconductor memory device in accordance with the embodiment of the present invention may control the level of the input reference voltage VREFIN through the first to fourth counting signals CNT<1:4>. Therefore, even though the number of reference voltages increases, the test time may not significantly increase.

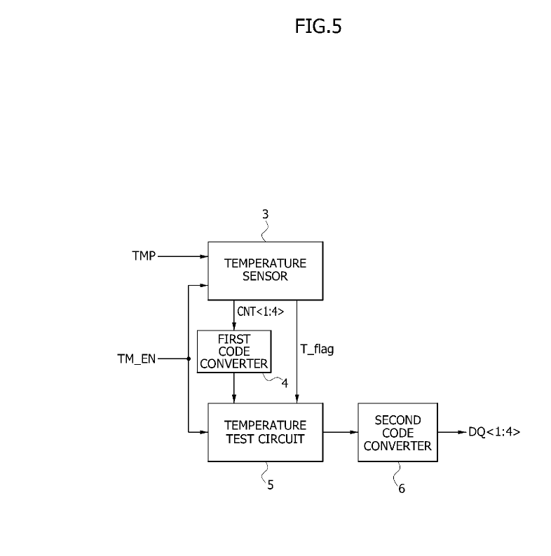

FIG. 5 is a block diagram of a semiconductor memory device in accordance with an embodiment of the present invention.

The configuration of the semiconductor memory device of FIG. 5 is characterized in that the semiconductor memory device includes a first code converter 4 and a second code converter 5. The first code converter 4 is configured to convert codes of first to fourth counting signals CNT<1:4> generated by a temperature sensor 3 and transmit the converted codes to a temperature test circuit 5. The second converter 6 is configured to recover the converted codes of the first to fourth counting signals CNT<1:4>, and output the first to fourth counting signals CNT<1:4> to first to fourth data pads DQ<1:4>.

The first code converter 4 may convert the first to fourth counting signals CNT<1:4> having binary codes into gray codes in which error occurrence is minimized and outputs the gray codes. The second code converter 6 may recover the first to fourth counting signals CNT<1:4> outputted as the gray codes into the first to fourth counting signals CNT<1:4> having binary codes.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A semiconductor memory device comprising:
a temperature sensor configured to select first and second selection reference voltages selected in a test mode as an input reference voltage according to first and second counting signals which are sequentially counted, compare the selected input reference voltage with a level of a variable voltage which changes according to internal temperature, and generate a temperature flag signal containing information on the internal temperature; and
a temperature test circuit configured to output the first and second counting signals at a time point where a level of the temperature flag signal changes.

2. The semiconductor memory device of claim 1, wherein the temperature test circuit comprises:
a pulse generation unit configured to generate a pulse signal at a time point where the level of the temperature flag signal changes; and
a buffer unit configured to buffer and output the first and second counting signals in response to the pulse signal.

3. The semiconductor memory device of claim 2, wherein the temperature test circuit further comprises an end pulse generation unit configured to generate an end pulse for resetting an output node of the buffer unit when the second counting signal is enabled.

4. The semiconductor memory device of claim 3, wherein the temperature test circuit further comprises a reset unit configured to reset the output node of the buffer at a time point where the pulse of the end pulse is inputted in the test mode.

5. The semiconductor memory device of claim 1, wherein the temperature sensor comprises:
a selection signal generation unit configured to generate a selection signal in response to a test mode pulse;
a reference voltage selection unit configured to select the first and second selection reference voltages among a plurality of reference voltages in response to the selection signal, and output the first and second selection reference voltages; and
a voltage pulse generation unit configured to count the first and second counting signals in response to an oscillation signal, decode the first and second counting signals to generate first and second test selection signals, and generate the input reference voltage and first and second latch pulses from the first and second test selection signals.

6. The semiconductor memory device of claim 5, wherein the voltage pulse generation unit comprises:
a counting signal generation section configured to generate the first and second counting signals which are counted in response to the oscillation signal in the test mode;
a counting signal decoder configured to decode the first and second counting signals and generate the first and second test selection signals and an end signal;
an input reference voltage selection section configured to select the first or second selection reference voltage as the input reference voltage in response to the first and second test selection signals; and
a latch pulse generation section configured to generate the first and second latch pulses in response to the first and second test selection signals.

7. A semiconductor memory device comprising:
a temperature sensor configured to select first and second selection reference voltages selected in a test mode as an input reference voltage according to first and second counting signals which are sequentially counted, compare the selected input reference voltage with a level of a variable voltage which changes according to internal temperature, and generate a temperature flag signal containing information on the internal temperature;
a first code converter configured to convert codes of the first and second counting signals;
a temperature test circuit configured to output the first and second counting signals of which the codes were converted by the first code converter, at a time point where a level of the temperature flag signal changes; and
a second code converter configured to convert the codes of the first and second counting signals outputted by the temperature test circuit.

8. The semiconductor memory device of claim 7, wherein the first code converter converts the first and second counting signals having binary codes into gray codes.

9. The semiconductor memory device of claim 7, wherein the temperature test circuit comprises:
a pulse generation unit configured to generate a pulse signal at a time point where the level of the temperature flag signal changes; and
a buffer unit configured to buffer and output the first and second counting signals in response to the pulse signal.

10. The semiconductor memory device of claim 9, wherein the temperature test circuit further comprises an end pulse generation unit configured to generate an end pulse for resetting an output node of the buffer unit when the second counting signal is enabled.

11. The semiconductor memory device of claim 10, wherein the temperature test circuit further comprises a reset unit configured to reset the output node of the buffer at a time point where a pulse of the end pulse is inputted in the test mode.

12. The semiconductor memory device of claim 7, wherein the temperature sensor comprises:
a selection signal generation unit configured to generate a selection signal in response to a test mode pulse;
a reference voltage selection unit configured to select the first and second selection reference voltages among a plurality of reference voltages in response to the selection signal, and output the first and second selection reference voltages; and
a voltage pulse generation unit configured to count the first and second counting signals in response to an oscillation signal, decode the first and second counting signals to generate first and second test selection signals, and generate the input reference voltage and first and second latch pulses from the first and second test selection signals.

13. The semiconductor memory device of claim 12, wherein the voltage pulse generation unit comprises:
a counting signal generation section configured to generate the first and second counting signals which are counted in response to the oscillation signal in the test mode;
a counting signal decoder configured to decode the first and second counting signals and generate the first and second test selection signals and an end signal;
an input reference voltage selection section configured to select the first or second selection reference voltage as the input reference voltage in response to the first and second test selection signals; and
a latch pulse generation section configured to generate the first and second latch pulses in response to the first and second test selection signals.

14. The semiconductor memory device of claim 7, wherein the second code converter converts the first and second counting signals, have been converted into gray codes, into binary codes.
